(19) United States
(12) Patent Application Publication
(10) Pub. No.: US 2025/0102392 A1
(43) Pub. Date: Mar. 27, 2025

(54) Anti-Leak System and Methods

(71) Applicant: The University of Bristol, Bristol (GB)

(72) Inventor: Alex Mavromatis, Bristol (GB)

(21) Appl. No.: 18/729,464

(22) PCT Filed: Feb. 10, 2023
(86) PCT No.: PCT/IB2023/051225

§ 371 Date: Jul. 16, 2024

(30) Foreign Application Priority Data
Jan. 17, 2022 (GR) 20220100042
Feb. 18, 2022 (GB) 2202246.1

(51) Int. Cl. G01M 3/18; G06N 3/0895

(52) U.S. Cl. CPC G01M 3/18; G06N 3/0895

(57) ABSTRACT

A method of training a leak prediction algorithm to predict leaks from pipework carrying a liquid, comprising: performing supervised training of a computer implemented leak prediction algorithm that receives, as an input, training measurement data from sensors monitoring an environment in proximity to the pipework and provides, as an output, a prediction of whether a leak is likely to occur in future; wherein the supervised training comprises adjusting parameters of the machine learning algorithm to improve the accuracy of the prediction, based on labels indicating which periods of the training measurement data correspond with one or more fault scenarios selected to cause leaks in future.

### FIELD OF INVENTION

The present invention relates to method of predicting and/or detecting leaks, and more particularly to a computer implemented method of predicting and/or detecting leaks.

### BACKGROUND

Water waste is a worldwide problem that has not yet been solved. Millions of tons of water are wasted daily, which results in loss of drinking water, loss of money and a lot of time and effort for peoples' day to day life. In the UK billions of litres of clean drinking water are wasted every day. Considering that water scarcity is a real threat to humanity there is not much being done to solve this long term issue. Water waste has increased over the years despite water companies and leak detection companies rolling out products and services that are intended to reduce the waste numbers.

Escape of water in a home results in significant damage and can be a significant source of water waste.

More than 40% of water damage in homes are the result of water escaping from pipes. Such leaks may be gradual, and have a number of potential causes including: broken pipes, frozen pipes, and blocked pipes. A typical cost of water escape in a home is 2300 Euros averaged over Europe and in the UK˜3300 EUR. Only 50% of leaks in homes are immediately detected, and the remaining 50% take up to 4 months to be detected. This slow detection of leaks is part of the reason why significant damage can be inflicted by even a relatively slow release of water. Slow leaks are hard to detect, which makes them capable of causing significant damage

Damage is not the only problem arising from leaks. A 3 mm hole in a pipe at typical domestic pressure could waste approximately 8000 litres of water in a day. Even a pinhead size hole can leak 1,363,750 litres in a year. Approximately 1 in 300 homes or buildings will experience a water leak. In an apartment building a leak can damage more than one home, and there are some settings in which water leaks have the potential to damage valuable items stored nearby. For example, a leak in a museum or gallery storage could inflict culturally significant damage before it is identified

An number of early leak detection solutions exist, but there remains significant room for improvement. In general, existing systems are designed to be retrofitted, and are intended to detect leaks as soon as they occur (typically using flow, pressure or acoustic sensors coupled to the pipes).

### SUMMARY

According to an aspect of the invention, there is provided a method of training a leak prediction algorithm to predict leaks from pipework carrying a liquid, comprising:
performing supervised training of a computer implemented leak prediction algorithm that receives, as an input, training measurement data from sensors monitoring an environment in proximity to the pipework and provides, as an output, a prediction of whether a leak is likely to occur in future:
wherein the supervised training comprises adjusting parameters of the machine learning algorithm to improve the accuracy of the prediction, based on labels indicating which periods of the training measurement data correspond with one or more fault scenarios selected to cause leaks in future.

The training measurement data may be obtained during controlled experiments in which the fault scenarios are introduced to a system of pipework carrying a liquid so as to cause leaks at a period of time after the introduction of the fault scenario.

The method may produce a computer implemented leak prediction algorithm that predicts leaks prior to them becoming significant.

The liquid may be water.

A significant leak may be more than 5 ml/min or more than 10 ml/min.

The one or more fault scenarios may comprise progressive decompression of a compression fitting.

The sensors monitoring the environment may comprise at least one of: a humidity sensor, a temperature sensor, and an atmospheric pressure sensor

The sensors may be placed within 30 cm of the pipework.

The sensors may be placed at a distance of between 2 cm and 30 cm of the pipework.

At least some of the sensors may be placed in an enclosed cavity with the pipework.

The method may further comprise training a first algorithm to classify measurement data as including a pattern.

The method further comprise training a second algorithm (for predicting whether a leak is likely to occur in future) using only the measurement data that is classified as having a pattern by the first algorithm.

The leak prediction algorithm may comprise an artificial neural network.

Each of the first algorithm and second algorithm may comprise a neural network.

According to a second aspect, there is provided a method of predicting leaks from water carrying pipework, comprising:
receiving measurement data from sensors monitoring an environment in proximity to the pipework;
providing the measurement data to a computer;
running a leak prediction algorithm on computer to process the measurement data and, responsive to an output from the leak prediction algorithm, providing an alert in the event a leak is predicted.

The leak prediction algorithm may have been trained according to the method of the first aspect, including any optional features thereof.

Providing the measurement data to the computer may comprise transmitting the measurement via a network.

The sensors may be distributed in different locations about the pipework.

The sensors may comprise sensor units, each configured to sense environments comprising: temperature, humidity and atmospheric pressure.

The sensor units may be spaced apart by a distance of at least 50 cm.

According to a third aspect, there is provided a system for predicting leaks from water carrying pipework, comprising:
a plurality of environmental sensors disposed in proximity to the pipework;
a computer, receiving environmental data measured by the plurality of environmental sensors and configured with a leak prediction algorithm that has been trained to predict leaks based on experimental data obtained during fault scenarios that will cause a leak in future.

The environmental sensors may comprise at least one of: a humidity sensor, a temperature sensor, and an atmospheric pressure sensor.

The sensors may comprise sensor units, each comprising a temperature sensor, humidity sensor and atmospheric pressure sensor.

Each sensor unit may comprise a wireless transmitter, for transmitting measurement data to the computer.

The leak prediction algorithm may have been trained according to the method of the first aspect.

Features of each aspect may be combined with those of any other aspect, including optional features.

### BRIEF DESCRIPTION OF THE DRAWINGS

FIGS. 1 and 2 show an experimental setup that can be used to obtain measurement data for training an artificial neural network;

FIG. 3 shows experimental steps for obtaining measurement data that may be used to train an artificial neural network;

FIG. 4 shows an example neural network for identifying patterns by hierarchical clustering;

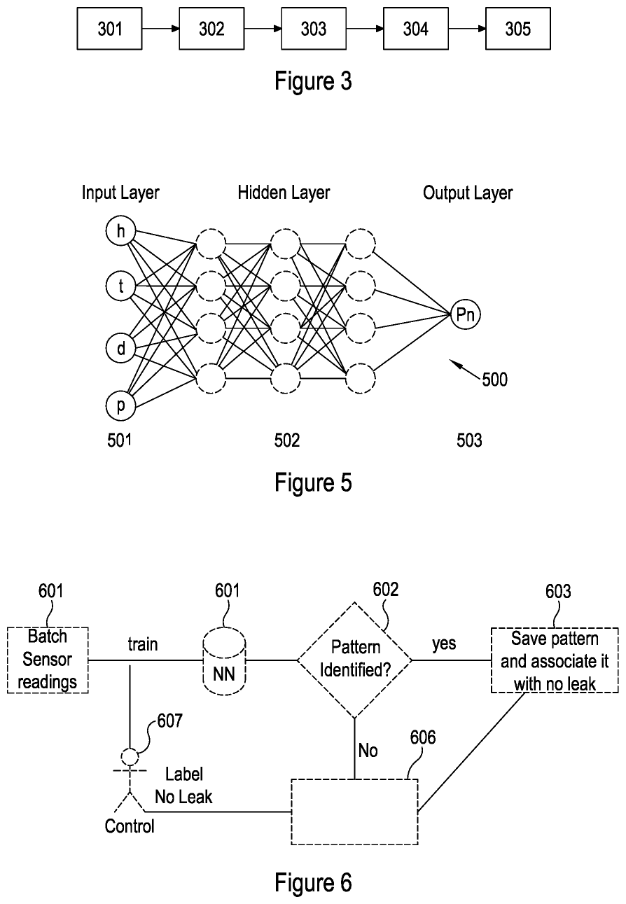

FIG. 3 shows an example neural network for pattern classification;

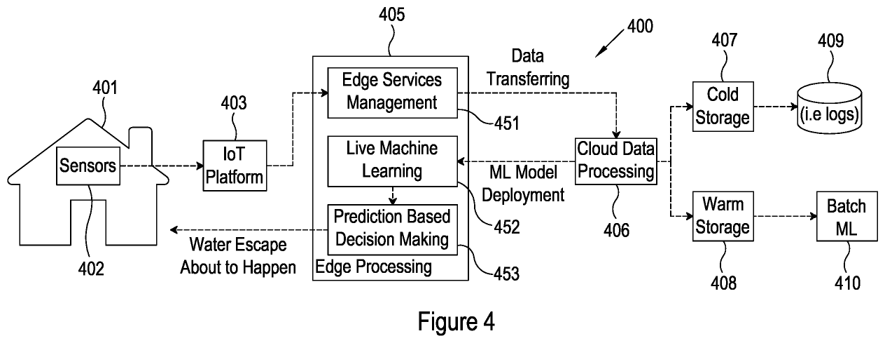

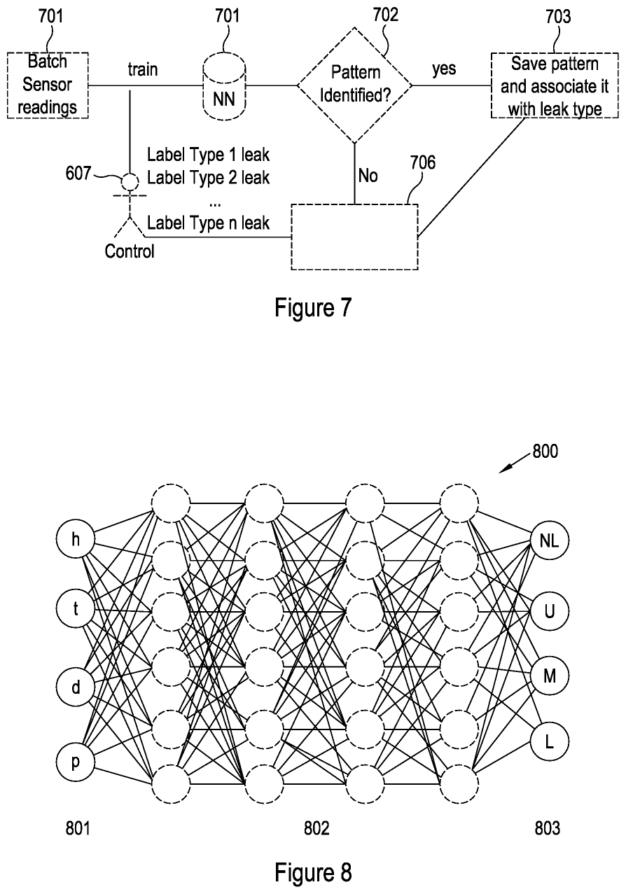

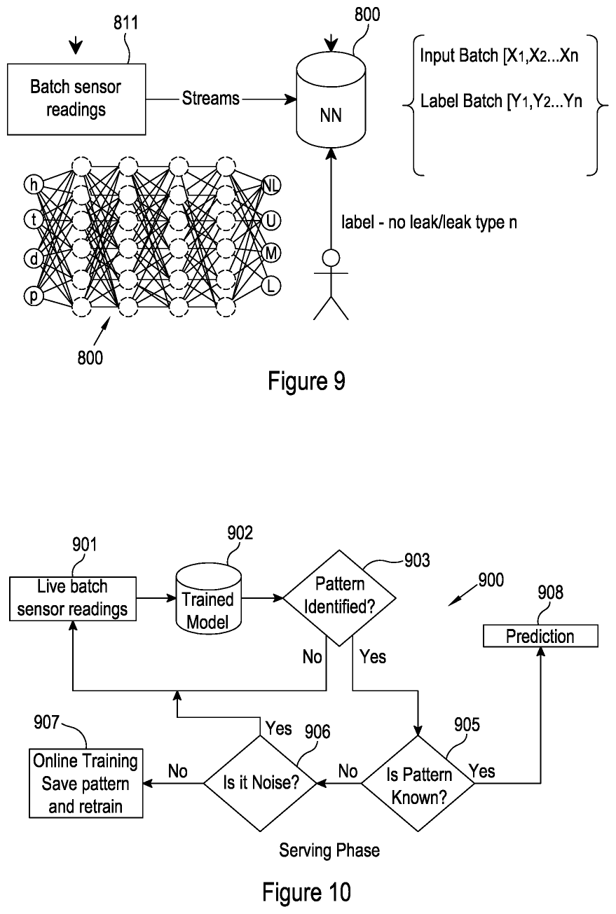

FIG. 4 shows a system according to an embodiment, illustrating a flow of information;

FIG. 4 shows an example method of training a pattern recognition neural network to recognise patterns associated with leaks;

FIG. 5 shows an example first neural network for recognising patterns;

FIG. 6 illustrates a first phase of training;

FIG. 7 illustrates a second phase of training;

FIG. 8 shows an example second neural network for classifying patterns (or more generally, measurement data);

FIG. 9 illustrates supervised training of the second neural network; and

FIG. 10 is a block diagram of a system for predicting leaks in service;

### DETAILED DESCRIPTION

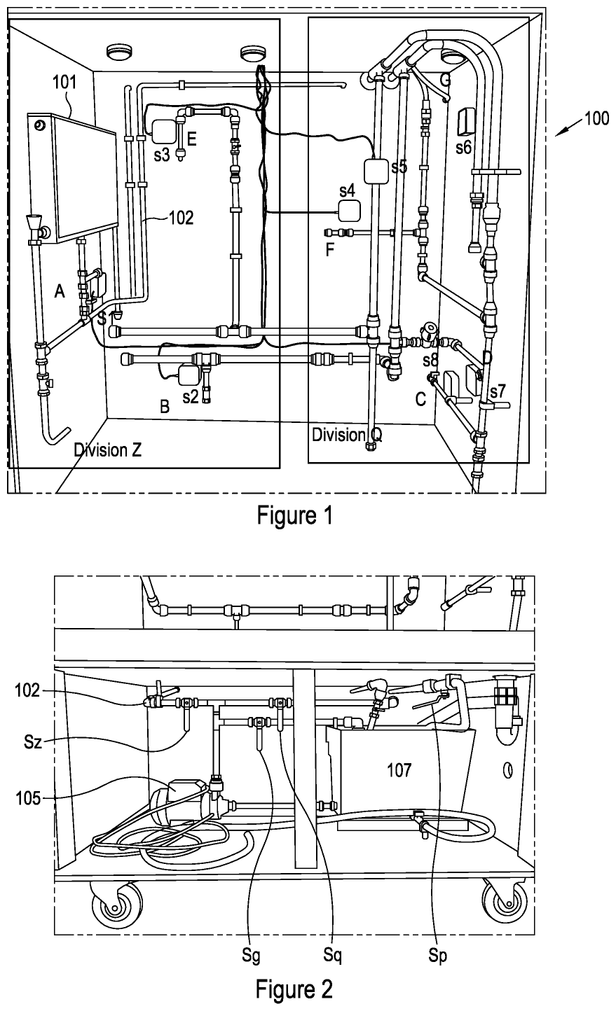

FIGS. 1 and 2 show a system 100 for obtaining measured environmental data from pipework 102 during experiments in which fault scenarios are induced. The fault scenarios are designed to lead to future leaks.

The system 100 comprises a pump 105 (shown in FIG. 2) which circulates water under pressure. The pump 105 receives water from tank 107 outputs water to the pipework 102. The pipework 102 returns water to the tank 107 via valve Sp. The valve Sp can thereby be used to control the pressure in the pipework 102.

The system is divided into 2 divisions (Division Z and Q) and 7 leakage points (A,B,C,D,E,F,G). The two divisions comprise left-side and right-side pipe systems that are supplied by the water pump independently via valves Sz and Sq respectively. A bypass flow path to the tank 107 is provided from the pump 105 via valve Sg.

The A and F leakage points as depicted each comprise compression fittings that are decompressed gradually in order to cause loss of circulating water. These compression fittings were adjusted to introduce fault scenarios, and the environment in proximity to the pipework monitored using sensors. For example, the compression fittings may be decompressed gradually (e.g. by a sequence of levels), with early decompression not sufficient to cause an escape of water, but sufficient to cause some other environmental change, detectable by the sensors.

In an example, the progressive decompression of the fittings at A and F leakage points may comprise adjustment of the compression fitting by 1, 2 and 4 mm, where 2 mm is the point where leakage (escape of water) starts and 4 mm creates a continuous leakage.

The D leakage point is a blocked pipe that is also controlled by a switch (white switch) to manage the pressure and leakage speed. The E leakage point is a hole in the pipe at around 2 mm that is manually controlled to leak. This leakage point produces a rapid escape a water when includes in the pressurised water circuit and the process here is somewhat on/off.

C and G leakage points are faulty installations of different compression fittings and mostly leak when only when water pressure is higher than 1 bar.

Sensors are deployed to monitor changes in the environment in proximity to the pipework. The sensors are listed as s1, s2, s3, s4, s5, s6, s7, s8 and are positioned according to each leakage points. Each sensor comprises at least a humidity, temperature and atmospheric pressure sensor.

The water pressure and water distribution are controlled by the following valves
Sz—Controlling the distribution of water to the Z division.
Sq—Controlling the distribution of water to the Q division
Sg—Bypassing the Z and Q division, circulating water to the tank 105
Sp—Controlling return of water from the Z and Q division to the tank 105, operable to vary the pressure of the circulating water in the Z and Q division.

Experiments were undertaken to introduce fault scenarios. Each fault scenario is selected to cause a leak in the future. Data was gathered from the sensors s1 to s8 during periods with no fault scenario, and during periods with specific fault scenarios. Each fault scenario may be considered as an experiment, as shown in FIG. 3.

At step 1 (301) the experiment starts and water is circulated in the selected division(s). At step 2 (302) a selected leakage point is subject to an initial fault condition that is not sufficient to cause a leak, but which may result in environmental changes in proximity to the pipe. For example, a change in humidity in proximity to a pipe may be detectable before a leak becomes significant. water becomes significant enough to cause any dripping from the pipework. If the pipework is hot, for example, the rate of evaporation may be relatively high. A slow leak may therefore increase the relative humidity in proximity to the pipe before any water drips from the pipework. There is therefore the potential to detect an escape of water from the pipework before it becomes a leak. A leak may be defined as the water leaving contact with the pipe (e.g. to damage something near to the pipework) in the form of a drip or stream.

At step 3 (303) the fault scenario severity may be escalated progressively, while data is monitored by the sensors. Escalating the fault scenario results in a leak.

In some embodiments, fault scenarios may be implemented with different severity levels. A low severity scenario may represent a fault condition that will result in a leak that will happen at least one week in the future. A medium severity scenario may represent a fault condition that will result in a leak at least a day in future, but in less than one week. A high severity scenario may represent a fault condition that will result in a leak in less than a day, for example within two hours.

At step 4 (304) the leakages are managed, and the measurement data is stored, along with fault scenario information indicating periods of measurement that correspond with the fault scenarios, and optionally information indicating periods of measurement that correspond with a leak.

At step 5 (305) the experimental data (comprising the measurement data and fault scenario information) are reported and stored ready to be used as training information for a supervised training of a computer implemented algorithm.

The measurement data from these controlled experiments can be used to train a computer implemented leak prediction algorithm that will predict whether a leak is likely to occur in future, before the leak occurs and causes damage.

FIG. 4 shows a system 400 according to an embodiment, comprising a home 401, sensors 402, IoT platform 403, edge processing 405, cloud data processing 406, cold storage 407, warm storage 408, cold storage database 409, and batch machine learning block 410.

The sensors 402 may be deployed during construction of the house 401, and distributed in positions in proximity to pipework within the house 401. For example, the pipework may be concealed behind plasterboard or in floor or ceiling voids. Sensors 402 may be disposed proximate to fittings that are more prone to failure (e.g. compression fittings) and or spaced apart by around 1 m in the region of the pipework. Placement within 30 cm of a floor may enable enhanced detection of environmental changes that are associated with fault conditions.

The sensors 402 provide data, via an IoT platform to an edge node 405, which may represent an internet connected server, for example. The edge node 405 hosts a number of services, and receives data via the IoT platform from the sensors 402. The edge node 405 hosts edge services management 451, live machine learning 452 and prediction based decision making 453.

Edge services management receives data from the sensors 402 via the IoT platform 403. Live machine learning 452 implements inference based on a pre-trained computer implemented algorithm leak prediction algorithm. Prediction based decision making 453 provides a notification based on the output from the live machine learning 452, for example to internet connected devices in the home 401 or elsewhere (e.g. a maintenance company, company responsible for the property, and/or an insurer).

The edge services management 451 transfers data to cloud node 406, which performs cloud hosted data processing. The cloud node 406 may perform training of computer implemented algorithms for predicting leaks based on data received from the sensors 402 via the edge node 405. For example, cloud node 406 may periodically update leak prediction algorithm based on new training data.

The cloud node 406 is able to store data in cold storage 407 (low cost, slow access) and warm storage 408 (higher cost and faster access than cold storage). Cold storage 407 may be appropriate for log files and archive information. Warm storage 408 may be appropriate for batches of data that may be deployed and used for training at the cloud node 406 or edge node 405.

The computer implemented algorithm for leak prediction may comprise a neural network, for example a feedforward neural network (e.g. a multi-layer perceptron neural network). Example neural networks are shown in FIGS. 5 and 6. In principle, any suitably trained computer implemented algorithm may be used to predict leaks from training information.

In an example embodiment a two stage approach may be used for the computer implemented algorithm. The first stage may comprise a first neural network that is configured to find patterns in the measurement data.

An example first neural network 500 is shown in FIG. 5, comprising a feedforward neural network (multi-layer perceptron) comprising an input layer 501, output layer 503 and hidden layers 502. The input layer 501 comprises four input neurons h, t, d, p. There are three hidden layers and the output layer 503 comprises a single output neuron Pn. Each of the four input neurons may receive a vector of samples encompassing a time period of a batch of sensor measurements. The batch period may be, for example, 2 minutes, and sensor readings may be taken every 0.5 second. The input neurons in this example receive humidity, temperature, dew point and atmospheric pressure (respectively corresponding with h, t, d, and p neurons).

The first feedforward neural network is configured to identify patterns in the data. The output Pn indicates whether the input data batch comprises a pattern. In some embodiments the first neural network may implement agglomerative hierarchical clustering. There may be two clusters—“pattern” and “no pattern”.

The first feed-forward NN is used for unsupervised clustering. No labels are given to the learning algorithm, leaving it on its own to find structure in its input (discovering hidden patterns in data). The NN is using a combination of loss functions based on cluster loss and network loss represented as:

$$L = λ L R + ( 1 - λ ) L C$$

Where L represents the overall loss, LR is the network loss and LC is the cluster loss. Network loss and cluster loss are well known terms of art, having their normal meaning. Despite the unsupervised approach the data being used for training are generated in a controlled environment, meaning that the batches identified as patterns at the end of the training are then tagged as leak A, leak B etc. This process will be conducted multiple times to package patterns in batched data and labels of what leak type they represent and what severity.

FIG. 6 illustrates a first phase of training an algorithm to predict leaks. In this stage the system illustrated in FIGS. 1 and 2 is operated without any fault condition in place, and measurement data obtained from the sensors s1 to s8. The measurement data is batched into batched sensor readings 601 (e.g. of duration 2 minutes, with samples every 0.5 seconds). The batched sensor readings 601 are provided to a neural network 601 (which may be first neural network 500 shown in FIG. 5).

The output from the neural network 601 is used at the subsequent pattern identification block 602 to determine whether a pattern is present in the input batch. For example a threshold or range may define whether the output from the neural network 601 identifies a pattern or not. If the pattern identification block 602 identifies that a pattern is present in the current batch, that batch is saved at block 603 and associated with a label that defines the pattern as a “no-leak” pattern (i.e. not associated with a fault scenario). If no pattern is identified the pattern identification of the batched input data by the neural network 601 continues as indicated by block 606.

FIG. 7 illustrates a second phase of training an algorithm to predict leaks. In this stage the system illustrated in FIGS. 1 and 2 is operated with fault conditions in place, and measurement data obtained from the sensors s1 to s8. The measurement data is again batched into batched sensor readings 701 (e.g. of duration 2 minutes, with samples every 0.5 seconds). The batched sensor readings 701 are provided to a neural network 701 (which may be first neural network 500 shown in FIG. 5).

The output from the neural network 701 is used at the subsequent pattern identification block 702 to determine whether a pattern is present in the input batch. For example a threshold or range may define whether the output from the neural network 701 identifies a pattern or not. If the pattern identification block 702 identifies that a pattern is present in the current batch, that batch is saved at block 703 and associated with a label that defines the pattern as a “leak” pattern (i.e. associated with a fault scenario). Each fault scenario may be designed with a specific severity, and the label defining the pattern as associated with a fault scenario may comprise an indication of the severity of the leak. For example, the fault scenarios may comprise: urgent, medium and low, with urgent fault conditions resulting in a leak within 2 hours or less, medium fault conditions resulting in a leak within a day to two hours, and low fault conditions resulting in a leak within a period of a week to one day.

If no pattern is identified the pattern identification of the batched input data by the neural network 701 continues as indicated by block 607.

In the first and second phases, batches of measurement data are saved that have patterns, and which are labelled as either “no leak” or “leak”. In a third phase, this saved data may be used to train a second neural network which is used to classify patterns as predictive of a future leak or not. An example of a suitable classification neural network is shown in FIG. 8.

An example second neural network 800 is shown in FIG. 8, comprising a feedforward neural network (multi-layer perceptron) comprising an input layer 801, output layer 803 and hidden layers 802. The input layer 801 comprises four input neurons h, t, d, p. There are four hidden layers and the output layer 803 comprises a plurality of different categories of classification. In this example, the categories comprise no-leak (NL), urgent (U), medium (M), and low (L). These faults categories correspond with the fault scenarios introduced during phase 2. A neuron is provided for each category of classification. The output of the second neural network is consequently a classification vector including a value representative of the likelihood or confidence that the data corresponds with each classification.

The classification neural network 800 may be trained using supervised learning, using the data obtained from the first and second phases. The labelled batches of sensor readings may be those obtained from the first and second phases, which have been classified by the first neural network as having a pattern. Since the patterns that have been saved in the first and second phases each have labels, the loss function used to train the classification neural network 800 may be based on an error between the output classification neurons and the labelled classification.

Each of the four input neurons may receive a vector of samples encompassing a time period of a batch of sensor measurements. The batch period may be, for example, 2 minutes, and sensor readings may be taken every 0.5 second. The input neurons receive humidity, temperature, dew point and atmospheric pressure (respectively corresponding with h, t, d, and p neurons).

FIG. 9 illustrates supervised training of the second neural network with labelled batches 811 of sensor readings.

FIG. 10 is a block diagram of a system 900 for predicting leaks in service (following training). Live batches of sensor readings 901 are provided from sensors disposed in proximity to pipework. The sensors may be in network communication with a server that receives the batches of measurement data, and which performs inference using a leak prediction algorithm to determine a prediction of whether a leak will occur in future. The live batches of sensor readings 901 are provided to a trained model 902. the trained model may comprise the second neural network described above, which provides an output which identifies whether a pattern is present in the input batch of data and provides a classification of the pattern. The output from the trained model 902 is used at the subsequent pattern identification block 903 to determine whether a pattern is present in the input batch. For example, a confidence threshold may be used to determine whether the output classification vector indicates there is a pattern in the data. If any of the classifications exceed a threshold, it may, for example, be inferred that there is a pattern. If no pattern is identified, a further batch of readings is analysed by the trained model 902.

If a pattern is identified, a pattern classification block 905 determines a classification for the pattern from the vector of classification values. If the second neural network has an classification vector that predicts a particular classification with a sufficient degree of confidence (e.g. above a threshold), a prediction 908 is produced from the output from the second neural network (e.g. the batch of data does not predict a leak (no leak), or the batch of data indicates a leak is likely within 2 hours (urgent).

If the second neural network has an output that has a low confidence (e.g. a confidence threshold is not met), the pattern is provided to a noise classification block 906. The noise classification block 906 identifies whether the pattern (detected by the first neural network and which is not classified with sufficient confidence by the second neural network) is noise.

If the noise classification block 906 determines that the pattern is not noise, the pattern is saved in order to use as a basis for further training of the neural network.

Although the specific example above uses a feedforward neural network as an example of a suitable computer implemented algorithm for predicting a future leak, in other embodiments a different computer implemented algorithm may be used. For example a convolutional neural network may be used. The examples use a two stage training architecture in which a first neural network identifies whether there is a pattern and a second neural network is trained using these patterns, but this is not essential. In some embodiments a single neural network may be trained on raw measurement data, but this may be less efficient. The example embodiments employ an input batch with fixed length having a fixed timestep. In other embodiments the input data provided to the neural network may be pre-processed, for example to transform the input data into the frequency domain, for example using a Fourier transform.

Embodiments enable prediction of future leaks, before damage is caused by water leaving the pipework.

Systems according to an embodiment may be integrated into houses (or other buildings) as they are constructed, so that the building is capable of predicting future leaks, thereby enabling remedial action before damage occurs. In some embodiments a system may be retrofitted to an existing building. In certain embodiments a system may be used to protect a valuable item from damage resulting from water leakage. For example, a museum or art gallery may have significant potential for damage to occur as a result of a water leak from pipework. Embodiments may be able to control risk arising from such leaks by predicting them before they occur.

The scope of the present invention is not intended to be limited by the example embodiments, but should be determined with reference to the accompanying claims.

1. A method of training a computer implemented leak prediction algorithm to predict leaks from pipework carrying a liquid, comprising:
performing supervised training of the computer implemented leak prediction algorithm that receives, as an input, training measurement data from sensors monitoring an environment in proximity to the pipework and provides, as an output, a prediction of whether a leak is likely to occur in future,
wherein the supervised training comprises adjusting parameters of the computer implemented leak prediction algorithm to improve the accuracy of the prediction, based on labels indicating which periods of the training measurement data correspond with one or more fault scenarios selected to cause leaks in future.

2. The method of claim 1, wherein the training measurement data is obtained during controlled experiments in which the one or more fault scenarios are introduced to a system of pipework carrying a liquid so as to cause leaks at a period of time after the introduction of the one or more fault scenarios.

3. The method of claim 1, wherein the method produces a computer implemented leak prediction algorithm that predicts leaks prior to them becoming significant.

4. The method of claim 1, wherein the one or more fault scenarios comprises progressive decompression of a compression fitting.

5. The method of claim 1, wherein the sensors monitoring the environment comprise at least one of: a humidity sensor, a temperature sensor, and an atmospheric pressure sensor.

6. The method of claim 1, wherein the sensors are placed within 30 centimeters (cm) of the pipework.

7. The method of claim 1, wherein at least some of the sensors are placed in an enclosed cavity with the pipework.

8. The method of claim 1, wherein the method further comprises training a first algorithm to classify measurement data as including a pattern.

9. The method of claim 8, wherein the method further comprises training a second algorithm using measurement data that is classified as having a pattern by the first algorithm.

10. The method of claim 1, wherein the leak prediction algorithm comprises an artificial neural network.

11. The method of claim 8, wherein each of the first algorithm and second algorithm comprise a neural network.

12. A method of predicting leaks from water carrying pipework, comprising:
receiving measurement data from sensors monitoring an environment in proximity to the pipework;
providing the measurement data to a computer; and
running a leak prediction algorithm on computer to process the measurement data and, responsive to an output from the leak prediction algorithm, providing an alert in the event a leak is predicted.

13. The method of claim 12, wherein the leak prediction algorithm has been trained according to the method of claim 1.

14. The method of claim 12, wherein providing the measurement data to the computer comprises transmitting the measurement data via a network.

15. The method of claim 12, wherein the sensors are distributed in different locations about the pipework.

16. The method of claim 1, wherein the sensors comprise sensor units, each configured to sense environments comprising: temperature, humidity and atmospheric pressure.

17. The method of claim 16, wherein the sensor units are spaced apart by a distance of at least 50 centimeters (cm).

18. A system for predicting leaks from water carrying pipework, comprising:
a plurality of environmental sensors disposed in proximity to the pipework; and
a computer, receiving environmental data measured by the plurality of environmental sensors and configured with a leak prediction algorithm that has been trained to predict leaks based on experimental data obtained during fault scenarios that will cause a leak in future.

19. The system of claim 18, wherein the environmental sensors comprise at least one of: a humidity sensor, a temperature sensor, and an atmospheric pressure sensor.

20. The system of claim 18, wherein the leak prediction algorithm has been trained by performing supervised training of the leak prediction algorithm that receives, as an input, training measurement data from sensors monitoring an environment in proximity to the pipework and provides, as an output, a prediction of whether a leak is likely to occur in future, and wherein the supervised training comprises adjusting parameters of a machine learning algorithm to improve the accuracy of the prediction, based on labels indicating which periods of the training measurement data correspond with one or more fault scenarios selected to cause leaks in future.
